(19) United States
(12) Patent Application Publication
(10) Pub. No.: US 2019/0094919 A1
(43) Pub. Date: Mar. 28, 2019

(54) Location-Based Augmented Reality Capture

(71) Applicants: iTagged Inc., Beverly, MA (US); iTagged Mobile Limited, Dublin (IE)

(72) Inventor: Keith Jordan, Dublin (IE)

(21) Appl. No.: 16/043,832

(22) Filed: Jul. 24, 2018

Related U.S. Application Data
(63) Continuation of application No. 15/531,169, filed on May 26, 2017, now abandoned.
(60) Provisional application No. 62/084,685, filed on Nov. 26, 2014.

(51) Int. Cl. G06F 1/16; H04N 5/225; H04N 5/247; H04W 4/02; H04N 5/44; G06T 19/00; G06F 3/0488; H04N 5/76; H04N 5/232

(52) U.S. Cl. CPC G06F 1/1686; H04N 5/2257; H04N 5/247; H04W 4/02; H04N 5/23245; G06T 19/006; G06F 3/0488; G06F 1/1694; H04N 5/76; H04N 5/44

(57) ABSTRACT

Featured is a method for location-based augmented reality capture. The method can include invoking an augmented reality capture mode on a device including a plurality of sensors, recording an augmented reality capture in response to user input, and storing the augmented reality capture. The device can be, for example, a smartphone, a tablet, or a laptop. Also featured is a device for location-based augmented reality capture embodying such a method(s). Such a device can be, for example, a smartphone, a tablet, or a laptop.

This application is a continuation of U.S. application Ser. No. 15/531,169 filed on May 26, 2017 which claims priority to National Stage filing of PCT/US2015/062396 filed on Nov. 24, 2015 which claims the benefit of U.S. Provisional Application Ser. No. 62/084,685 filed Nov. 26, 2014, the teachings of which are incorporated herein by reference in its entirety.

### BACKGROUND OF INVENTION

Augmented reality (AR) refers to the live direct or indirect view of a physical, real-world environment. The elements of the real-world environment can be augmented or supplemented with computer-generated sensory inputs such as sound, video, graphics, or GPS data. Augmented reality technology can function by enhancing a user's current perception of reality.

Methods of capturing visual media can require a user to capture a real world experience by specifying the format of visual media, e.g., a photograph or a video, and displaying the visual media in the specified format to the user. The visual media can then be stored on the device.

### SUMMARY OF THE INVENTION

The disclosed subject matter can include a method for location-based augmented reality capture. The method can include invoking an augmented reality capture mode on a device including a plurality of sensors, recording an augmented reality capture in response to user input, and storing the augmented reality capture. The device can be, for example, a smartphone, a tablet, or a laptop.

In accordance with one embodiment of the disclosed subject matter, the plurality of sensors include a location sensor. The location sensor can be, for example, a GPS sensor. The plurality of sensors can further include a digital imaging sensor such as a camera or a video sensor.

Invocation of an augmented reality capture mode can include initializing the digital imaging sensor, the location sensor, and one or more additional onboard sensors. For example, invocation of the augmented reality capture mode can include initializing at least one of a temperature sensor, an accelerometer, a gyroscope, or an audio sensor. In accordance with another embodiment of the disclosed subject matter, invocation of the augmented reality capture mode can include requesting information from remote sensors, network databases, websites, or third party services.

The augmented reality capture can include visual media and an information layer. The visual media can be, for example, a video or a photograph. The information layer can include location data. The information layer can also include other augmented reality (AR) data. Other augmented reality data can include directions, audio files, user interface elements, telephone numbers, catalog data, video, or information from remote sensors, local databases, network databases, or websites.

The augmented reality capture can be recorded in response to user input such as haptic contact or voice commands For example, recording can commence when haptic contact is sensed and conclude when haptic contact is disengaged. In accordance with another embodiment of the disclosed subject matter, recording can commence when a first haptic contact is sensed and conclude when a second haptic contact is sensed. Recording can include storing data received in response to invocation of the augmented reality mode, including storing measurements from onboard sensors and storing information received from remote systems such as remote sensors or third party services.

The augmented reality capture can be stored locally or remotely. In accordance with one embodiment of the disclosed subject matter, the user can play back the augmented reality capture at a later time.

Also featured is a device for location-based augmented reality captures, that includes a digital processing device; and a software program including one or more of instruction, criteria and code segments for carrying out any of the herein described methods for location-based augmented reality capturers. Such a method more particularly includes: invoking an augmented reality capture mode on a device including a plurality of sensors; recording an augmented reality capture in response to user input; and storing the augmented reality capture.

Other aspects and embodiments of the invention are discussed below.

### BRIEF DESCRIPTION OF THE DRAWING

For a fuller understanding of the nature and desired objects of the present invention, reference is made to the following detailed description taken in conjunction with the accompanying drawing figures wherein like reference character denote corresponding parts throughout the several views and wherein:

FIG. 1 is a block diagram view of device according to an embodiment of the present invention.

FIG. 2 illustrates an embodiment of a method for location-based augmented reality captures.

### DESCRIPTION OF THE PREFERRED EMBODIMENT

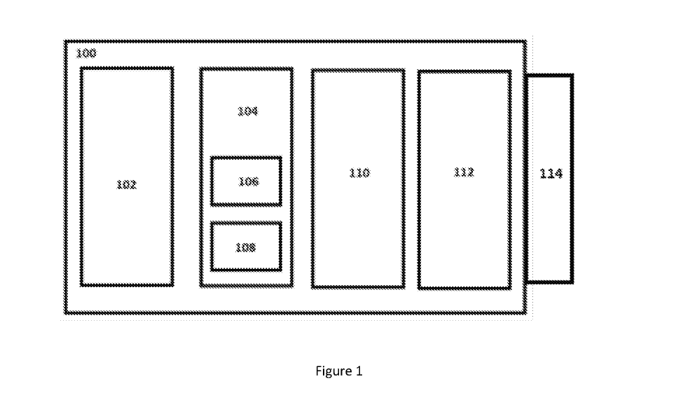

In accordance with one aspect, the disclosed subject matter includes a device for location-based augmented reality capture. FIG. 1 shows a block diagram of a device 100 in accordance with an exemplary embodiment of the disclosed subject matter. The device 100 can be, for example, a mobile device such as a smartphone or a tablet. In accordance with another embodiment of the disclosed subject matter, the device 100 can be a laptop computer. The device includes one or more processors, each of which can include one more electronic circuits including, for example, computer processor units (CPUs), graphics processor units (GPUs), integrated circuits, and semiconductor devices such as transistors.

Device 100 can include one or more sensors 102. The one or more sensors can include a digital image sensor such as a semiconductor charge-coupled device or an active pixel sensor in, e.g., complementary metal-oxide-semiconductor (CMOS) or N-type metal-oxide-semiconductor (NMOS) technologies. However, other sensors for capturing images or other visual media (e.g., images or video) can also be used in accordance with the disclosed subject matter.

Device 100 can also include a user interface 104. The user interface 104 can include, for example, a display 106 and a user input device 108. The user input device 108 can be, for example, a keyboard. In accordance with certain embodiments of the disclosed subject matter, device 100 can include a touchscreen which, together with any associated software, comprises both the display 106 and the user input device 108. The user input device 108 can sense haptic contact from the user, e.g., via a keyboard or a touchscreen. In accordance with other embodiments of the disclosed subject matter, the user input device 108 may sense audio, e.g., voice commands

Device 100 can further include one or more onboard sensors 110. The onboard sensors 110 can include a location sensor. The location sensor may use global positioning system (GPS) technology to determine the location of the device. Other known methods for determining the location of the device 100 can also be used. The onboard sensors 110 can also include other sensors such as, for example, a temperature sensor, an accelerometer, and/or a gyroscope. The onboard sensors 110 can also include an audio sensor.

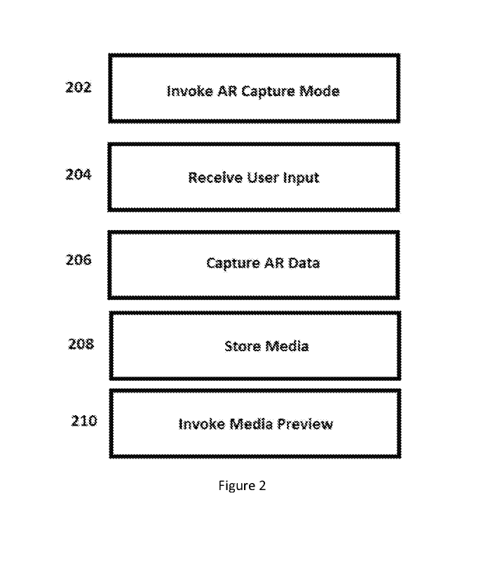

The device can further include a non-transient computer readable medium 112. The computer readable medium 112 can include, for example, Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium. The computer readable medium 112 can store, among other things, executable instructions which, when executed, cause the one or more processors to perform the steps described in, for example, FIG. 2.

The device can further include a transceiver 114. The transceiver 114 can provide a communications link between the device 100 and other devices. The transceiver 114 can be a wired connection such as a USB port, or a wireless connection such as an antenna. The device 100 can communicate via the transceiver 114 using any communication protocol. For example, the device 100 can communicate using GSM, GPRS, EDGE, 802.x communication sub systems (e.g., 802.11), CDMA, Bluetooth, TCP/IP protocols, UDP protocols, or other known protocols.

In accordance with embodiments of the disclosed subject matter, transceiver 114 can further operate to gather additional data from remote sources. For example, transceiver 114 can communicate with a cloud-based or server-based system to collect data from remote sensors. The data collected from the remote systems can be based on the location of the device. Transceiver 114 can transmit location data to the cloud-based or server-based system, and data from remote sensors corresponding to the location data can be returned to the transceiver 114.

In accordance with another embodiment of the disclosed subject matter, transceiver 114 can communicate with a third party service to receive information. The device 100 can use an Application Programming Interface (API) for communication with the third party service through the transceiver 114. The device 100 can provide location data to the third party service via the transceiver 114. The third party service can provide, for example, directions, telephone numbers, or other information to the device 100 based on the location data. In accordance with another aspect, the disclosed subject matter can provide a method for location-based augmented reality capture. FIG. 2 illustrates a method for location-based augmented reality capture in accordance with an exemplary embodiment of the disclosed subject matter. Device 100 can invoke augmented reality (AR) capture mode at 202. In accordance with an exemplary embodiment of the disclosed subject matter, invocation of the AR capture mode can include providing instructions to turn on the onboard sensors 110 and the transceiver 114 for reception of AR data. For example, invocation of AR capture mode can include turning on a digital imaging sensor, a location sensor and at least one other onboard sensor such as, for example, a temperature sensor, an accelerometer, and/or a gyroscope. However, in accordance with some embodiments of the disclosed subject matter, certain sensors (e.g., the digital imaging and/or location sensors) can be initialized prior to invocation of the AR capture mode.

In accordance with embodiments of the disclosed subject matter, invocation of the AR capture mode can include turning on a plurality of other onboard sensors. Invocation of AR capture mode can initialize receipt of data through the relevant sensors, but does not require recording of the received data.

Invocation of AR capture mode can further include requesting data from remote devices. For example, invocation of AR capture mode can include transmitting a request for data from one or more remote sensors via transceiver 114 and receiving data from the one or more remote sensors. The request can include location data and the device 100 can receive data from the one or more remote sensors based on the location data. For example, a device 100 can receive data from remote sensors located at or around the geographic location identified in the location data. Data can be received once in response to each request, or can be received as a data stream that is periodically updated until AR mode is canceled.

In accordance with another embodiment of the disclosed subject matter, invocation of AR capture mode can include communicating with a third party service using, for example, an API. The device 100 can provide location data to the third party service via the API, and the third party service can return information related to the geographic location corresponding to the location data to the device 100. Data can be received once in response to each communication using the API, or can be received as a data stream that is periodically updated until AR mode is canceled.

In accordance with one embodiment of the disclosed subject matter, AR capture mode can be invoked by creating a new object. For example, a user can create a new tag on a map corresponding to the user's location. In another example, the user can create a new tag or other object in an augmented reality view. AR mode can be automatically invoked upon creation of the new tag. The user can also provide a tag name or other data (e.g., a text comment for description of the tag).

In accordance with another embodiment of the disclosed subject matter, AR mode can be invoked by accessing a previously-created object. For example, a user can access a previously-created tag on a map corresponding to or near a user's location. In another example, a user can access a tag or other object left by another user in an augmented reality view.

The device can then receive user input at 204. The user input can be, for example, haptic input via a touchscreen, a keyboard, or another touch sensor. For example, the device can receive persistent haptic contact from the user to indicate that the user desires to record relevant information for the entire time during which the haptic contact continues. In accordance with other embodiments of the disclosed subject matter, the device can receive user input in other ways, e.g., via voice commands User input can be received via a user interface 104 as described above.

In response to the user input, the device can capture augmented reality (AR) data at 206. Augmented reality data can include visual media received from digital image sensors. The media can be, for example, a video or a photograph. Augmented reality data can also include location data such as global positioning system (GPS) data. Data from all other onboard sensors that were primed by invocation of AR capture mode can also be captured. Such data can include, for example, a time stamp, temperature information, device speed, device orientation, audio files, and the like. The AR data can also include other information available on the device, e.g., information input by the user and/or information stored on local databases. In accordance with embodiments of the disclosed subject matter, the device can also capture information provided from remote systems via transceiver 114. Such information can include data from remote sensors, directions, audio files, user interface elements, text, telephone numbers, catalog data, video, and information from network databases, or websites. The device can also capture information provided from third party services, e.g., using APIs.

The AR data can be recorded for a time period defined by the user input. For example, in accordance with an exemplary embodiment of the disclosed subject matter, AR data can be recorded from the time when user input (e.g., haptic contact) begins until the time when user input ends. In such a situation, AR data can be captured when the user input is first received and additional measurements can be captured as they are received from onboard sensors 110 and/or transceiver 114 during the defined time period.

The device can store AR data at 208. The AR data can be stored locally on a storage device within device 100. The storage device can be, for example, Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of tangible storage medium. The AR data can be stored on the same storage device that stores the instructions which cause the processor to perform the method.

In accordance with another embodiment, the AR data can be stored on a remote device. For example, the AR data can be transmitted from the device via a wireless transmitter to a remote database. In accordance with another embodiment of the disclosed subject matter, the AR data can be transmitted to the remote database using a wired connection. For example, the AR data can be communicated via a USB cable coupled to a USB port of the device. The remote database can operate as a cloud-based web service. Storage on a remote database, can alternatively follow step 210, can allow other users to access the AR capture. For example, when another device is operating in augmented reality view mode, an object representing one or more stored AR captures can appear on the display. In response to the user selecting the object, the AR capture can be made available to the user. Where more than one AR capture is associated with a particular tag or other object, a timeline including each such AR capture can be displayed to the user upon selection of the object. The timeline can permit the user to view changes over time (e.g., for the construction of a building or the changing of the seasons) or the sequence of an event (e.g., a wedding with AR captures in chronological order).

The device can then invoke a media preview at 210. The device can playback the AR data. In accordance with certain embodiments of the disclosed subject matter, the AR data can be played back immediately following the termination of the recording period. The playback can include, for example, playback of a combined information layer, location data, and sensor data. The device can provide the user an opportunity to supplement the captured AR data. For example, the device can allow the user to add text or additional media files to the AR data. In accordance with another embodiment, the device can allow the user to choose whether the AR data can be made available to others and/or how long the AR data will be available to others. After the user has added (or declined to add) additional information, the AR capture can be stored locally and/or remotely as previously described.

Computer software includes operating systems and user programs such as that to perform the actions or methodology of the present invention as well as user data that can be stored in a computer software storage medium, such as a storage medium within the device, the memory, and/or an external storage for execution on the computer/server. Executable versions of computer software, such as browser, operating system, and other operating software can be read from a non-volatile storage medium such as a storage device within the device, an external storage, and non-volatile memory and loaded for execution directly into the volatile memory, executed directly out of the non-volatile memory, or storage medium within the device prior to loading into the volatile memory for execution on the computer processor.

The flow charts and/or description herein illustrate the structure of the logic(s) of the present invention as embodied in a computer program software for execution on a computer, digital processor or microprocessor. Those skilled in the art will appreciate that the flow charts and the description herein illustrate the structures of the computer program code elements, including logic circuits on an integrated circuit that function according to the present invention. As such, the present invention is practiced in its essential embodiment(s) by a machine component that renders the program code elements in a form that instructs a digital processing apparatus (e.g., computer) to perform a sequence of function step(s) corresponding to those shown in the flow diagrams and/or as described herein.

The presently disclosed subject matter is not to be limited in scope by the specific embodiments herein. Indeed, various modifications of the disclosed subject matter in addition to those described herein will become apparent to those skilled in the art from the foregoing description and the accompanying figures. Although a preferred embodiment of the invention has been described using specific terms, such description is for illustrative purposes only, and it is to be understood that changes and variations may be made without departing from the spirit or scope of the following claims.

What is claimed is:

1. A method for location-based augmented reality capture, said method comprising the steps of:
invoking an augmented reality capture mode on a device including a plurality of sensors;
recording an augmented reality capture in response to user input; and
storing the augmented reality capture.

2. The method of claim 1, wherein the device is one of a smartphone, a tablet, or a laptop.

3. The method of claim 1, wherein the plurality of sensors includes one of a location sensor and a digital imaging sensor

4. The method of claim 3, wherein the location sensor include a GPS sensor and the digital imaging sensor includes one of a camera or a video sensor.

5. The method of claim 3, wherein said invoking the augmented reality capture mode includes initializing the digital imaging sensor, the location sensor, and one or more additional onboard sensors.

6. The method of claim 1, wherein said invoking the augmented reality capture mode includes initializing at least one of a temperature sensor, an accelerometer, a gyroscope, or an audio sensor.

7. The method of claim 1, wherein said invoking the augmented reality capture mode includes requesting information from at least one of remote sensors, network databases, websites, or third party services.

8. The method of claim 1, wherein the augmented reality capture includes visual media and an information layer.

9. The method of claim 8, wherein the visual media includes at least one of a video or a photograph and wherein the information layer includes one of location data or augmented reality data, wherein the augmented reality data includes at least one of directions, audio files, user interface elements, telephone numbers, catalog data, video, or information from remote sensors, local databases, network databases, or websites.

10. The method of claim 1, wherein said recording an augmented reality capture in response to user input further includes recording an augmented reality capture in response to haptic contact or voice commands

11. The method of claim 10, wherein recording commences when a first haptic contact is sensed and concluded when a second haptic contact is sensed.

12. The method of claim 1, wherein said recording includes storing data received in response to invocation of the augmented reality mode, storing measurements from onboard sensors and storing information received from remote systems such as remote sensors or third party services.

13. The method of claim 1, wherein the augmented reality capture is stored one of locally or remotely.

14. A device for distributing location-based augmented reality captures, comprising:
a digital processing device; and
a software program including one or more of instruction, criteria and code segments for carrying out a method for distributing location-based augmented reality captures, said method comprising the steps of:
invoking an augmented reality capture mode on a device including a plurality of sensors;
recording an augmented reality capture in response to user input; and
storing the augmented reality capture.
